(19) United States
(12) Patent Application Publication
(10) Pub. No.: US 2003/0189330 A1
(43) Pub. Date: Oct. 9, 2003

(54) Transport and storage trailer

(76) Inventor: William Dennis, Peoria, AZ (US)

Correspondence Address: ELLIS & VENABLE, PC, 101 NORTH FIRST AVE., SUITE 1875, PHOENIX, AZ, 85003, US

(21) Appl. No.: 10/400,352

(22) Filed: Mar. 25, 2003

Related U.S. Application Data
(60) Provisional application No. 60/368,278, filed on Mar. 26, 2002.

(51) Int. Cl. B62D 63/06

(52) U.S. Cl. 280/789

(57) ABSTRACT

A transport and storage trailer to transport a gas container having features that facilitate safe and secured storage of the fuel container as an unattended fuel source. The trailer includes a main frame having attached wheels and a hitch-receiving end for connection to a standard trailer hitch and a mechanism for safe and secured storage orientation. The mechanism for safe and secured storage orientation comprises an anchoring mechanism that secures the trailer and attached fuel container in a secured storage orientation. The secured storage orientation facilitates hook-up to a fuel inlet valve, which is ordinarily coupled by a hose that is ultimately connected to an inlet for the destined gas using apparatus (e.g. gas inlet of a home). The safe and secured storage orientation resists external forces that might topple the fuel container resulting in hazardous conditions.

This application claims benefit of earlier filed provisional application number 60/368,278 filed on Mar. 26, 2002.

### BACKGROUND OF THE INVENTION

1. Field of the Invention

The invention is applicable in the field of trailers and gas container storage systems.

2. Related Art

Several patents issued described related inventions. U.S. Pat. Nos. 2,624,483, 3,208,614, 1,896,249, 4,098,416, 5,779,255, 831,701, 720,422, 2,772,010, 372,137, 2,476,539, 2,078,119, and 5,464,237. Yet, none of the above patents, either alone or in combination, disclose or suggest the invention described in the subject application.

### SUMMARY OF THE INVENTION

In most general terms, the invention is summarized as a trailer to transport a fuel container having features that facilitate safe and secured storage of the fuel container as an unattended fuel source. The trailer comprises a main frame having attached wheels and a hitch-receiving end for connection to a standard trailer hitch and a mechanism for safe-and secured storage orientation. The mechanism for safe and secured storage orientation comprises an anchoring mechanism that secures the trailer and attached fuel container in a secured storage orientation. The secured storage orientation facilitates hook-up to a fuel inlet valve, which is ordinarily coupled by a hose that is ultimately connected to an inlet for the destined gas using apparatus (e.g. gas inlet of a home). The safe and secured storage orientation resists external forces that might topple the fuel container resulting in hazardous conditions.

Aspects or features of the invention may be embodied in, a base at one end of the frame and on which, when the trailer is in the secured storage orientation substantially all of the mass of the fuel container will rest and also prevent the fuel container from traveling in a direction substantially parallel to a longitudinal cavity circumscribed at least partially by rails that restrain the fuel container from moving in a direction substantially perpendicularly to the longitudinal cavity. The longitudinal cavity also having a fuel container-restraining structure at the end of the longitudinal cavity opposite the base that also prevents the fuel container from traveling in a direction substantially parallel to the longitudinal cavity.

Aspects or features of the invention may be alternately embodied, as is the case wherein a fuel container cradle includes aspects of the frame described above. The fuel container cradle incorporates the base at one end and on which at least a portion of the mass of the storage fuel container will periodically rest, and fuel container cradle rails that circumscribe a longitudinal fuel container cavity. The fuel container cradle prevents a fuel container from traveling in a direction substantially parallel and perpendicularly to the longitudinal cavity. The fuel container cavity also has a fuel container-restraining structure towards the end of the longitudinal cavity opposite the base that also prevents the fuel container from traveling in a direction substantially parallel to the longitudinal cavity. The fuel container cradle is pivotally attached to the frame at the base end of the fuel container cradle such that the longitudinal cavity of the fuel container cradle can be secured at at least two different angles from the frame.

Aspects of the base of the frame or fuel container cradle are specific security and safety features including components of an anchoring mechanism to deter unsafe and undesirable movement of the trailer from a storage position.

Aspects are also contemplated to include slight modifications that are substantially equivalent. Modifications of the invention separate the base and anchoring mechanism from the trailer or cradle. Thus, one alternate embodiment will include a fuel container trailer (with or without fuel container cradle) and independent base.

Further aspects are contemplated and include modifications to the frame or the fuel container cradle to permit multiple fuel canisters to be used. Contemplated modifications include obvious enlargement of the fuel container cradle or the frame.

### BRIEF DESCRIPTION OF THE FIGURES AND PHOTOS

The figures and photos described below are for teaching purposes only. The claims that follow the description of embodiments are intended to circumscribe the scope of the invention.

FIG. 1A illustrates a side view of one embodiment showing a frame and the trailer hitch receiving hardware which includes a fuel container cradle that is to be pivotally attached to the frame;

FIG. 1B illustrates a preferred base 12 of the frame or fuel container cradle, depending on the embodiment, and an aperture or eyelet 14—a component of an embodiment of the anchoring mechanism, and a safety rim 16 that restricts movement of the fuel container;

FIG. 1C illustrates a brace 103 for securing the fuel container cradle in at least two different angles relative from the frame 1;

FIG. 2A illustrates a top view of the fuel container cradle or the frame rails 10 for securing the fuel container;

FIG. 2B illustrates a top view of the securing structure for securing the fuel container to the frame 1;

FIG. 3 illustrates top views of the main frame of the trailer chassis;

### DESCRIPTION OF EMBODIMENTS

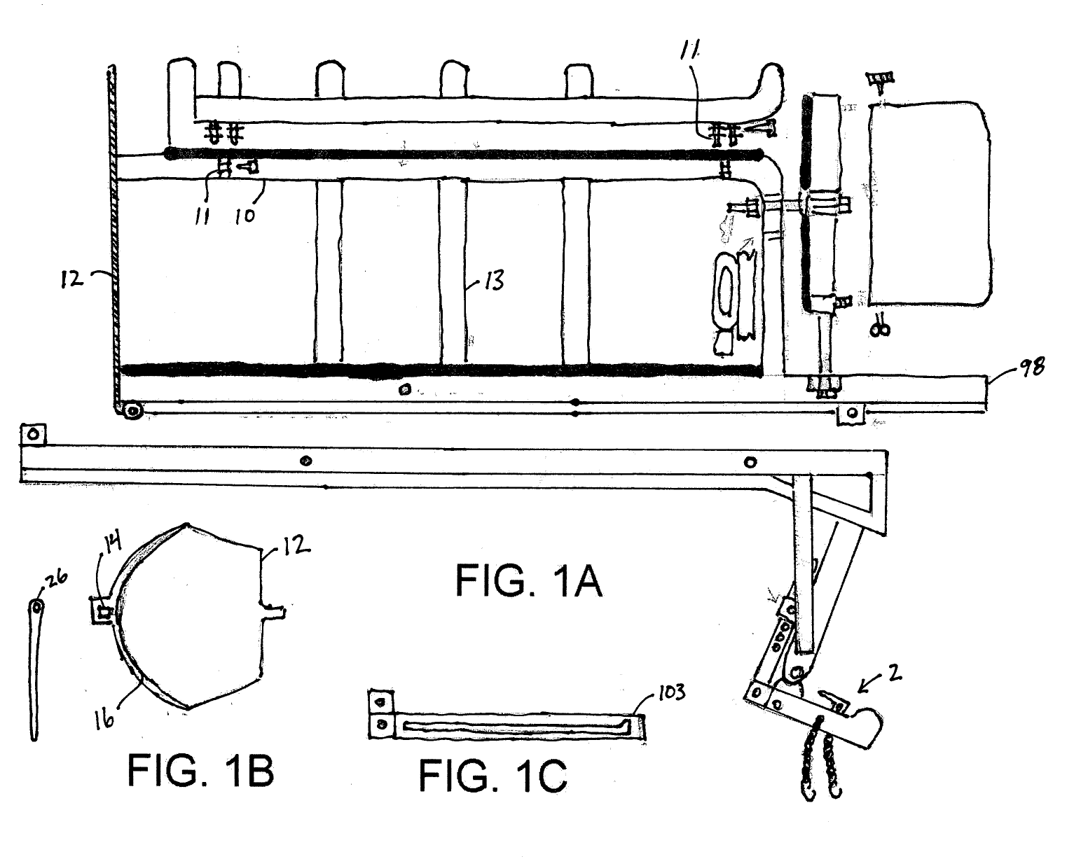

FIGS. 1A-1C illustrate components of one embodiment incorporating aspects of a first securable transport apparatus for a tank. In this embodiment, the trailer further comprises a fuel container cradle 98 that is pivotally attached to the trailer frame. The frame includes a hitching structure secured to the frame for receipt of a vehicle hitch and at least two wheels each secured to a side of the frame to facilitate ordinary transport of the apparatus. The frame further comprises a base 12 coupled at a substantially perpendicular angle to the frame and at a distal end of the frame, and at least one longitudinal frame rail 10 secured to at least one transverse frame bracket 13.

FIG. 1A illustrates features of a preferred fuel container cradle 98 having a base 12 at one end of the substantially longitudinal cavity circumscribed by the fuel container cavity rails 10. The fuel container cradle is comprised of the base 12, the fuel container restraining structure, and fuel container cradle rails 10 that restrict movement of an attached fuel container. FIG. 1C depicts a brace 14 for securing the fuel container cradle in at least two different angles with respect to the trailer frame 1. The brace 14 is pivotally attached to the frame at a medial position and interposed between the frame and cradle 98. The brace 14 is extendable away from the frame to brace and secure the cradle 98 in at an alternate angle to facilitate filling of the gas container when in transport orientation.

The first embodiment also comprises an anchoring mechanism having a first portion secured to an independent foundation, and a second portion secured to frame. The second and first portions are securable to each other and secure the frame in a substantially vertical storage orientation. One preferred first portion of the anchoring mechanism comprises a rod or protrusion secured to and extending from the foundation. A preferred second portion of the anchoring mechanism comprises an aperture or eyelet in the base 12 adapted to receive the rod or protrusion. FIG. 1B illustrates a top view of the base 12, which comprises a rim 16 that extends substantially perpendicularly from the base 16 and that restricts fuel container movement. FIG. 1B also illustrates the preferred second portion of the anchoring mechanism described above and a component of a preferred anchoring mechanism.

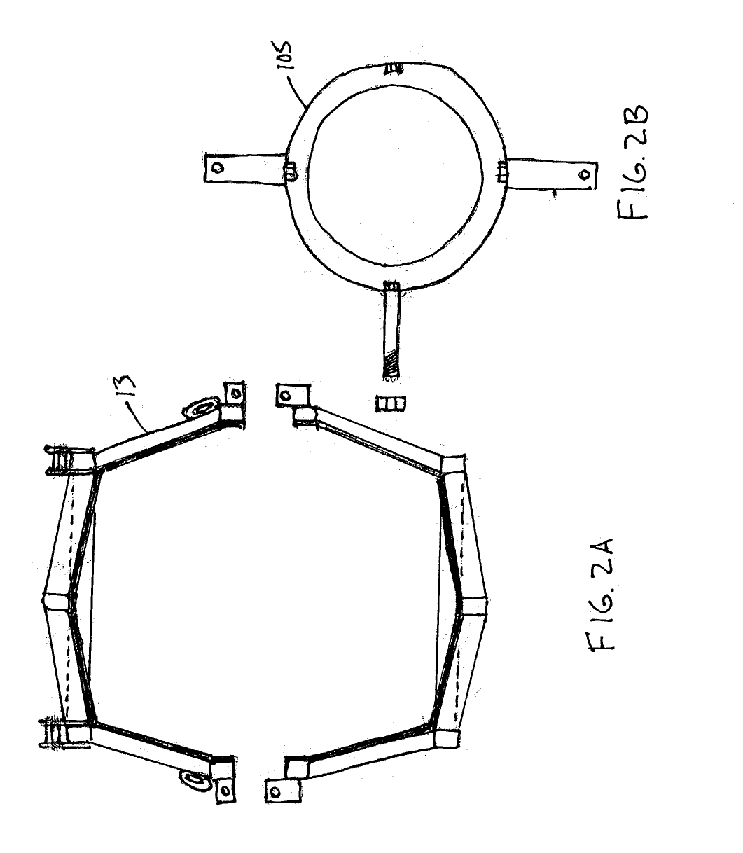

FIG. 1A also illustrates a preferred frame construction comprising two portions hingedly 111 attached along a frame rail 10. It is preferred that the two portions be hingedly 111 attached on either side of the cavity circumscribed by the frame rails 10 to facilitate opening of the frame in two directions to facilitate loading of a gas canister within. FIGS. 2A and 2B illustrate a top view of the frame cradle showing the two portions capable of being hingedly secured. FIG. 2B also illustrates a preferred annular ring lock 105 that engages and secures the top portion of the gas canister and further having spokes that extend to the frame rails 10.

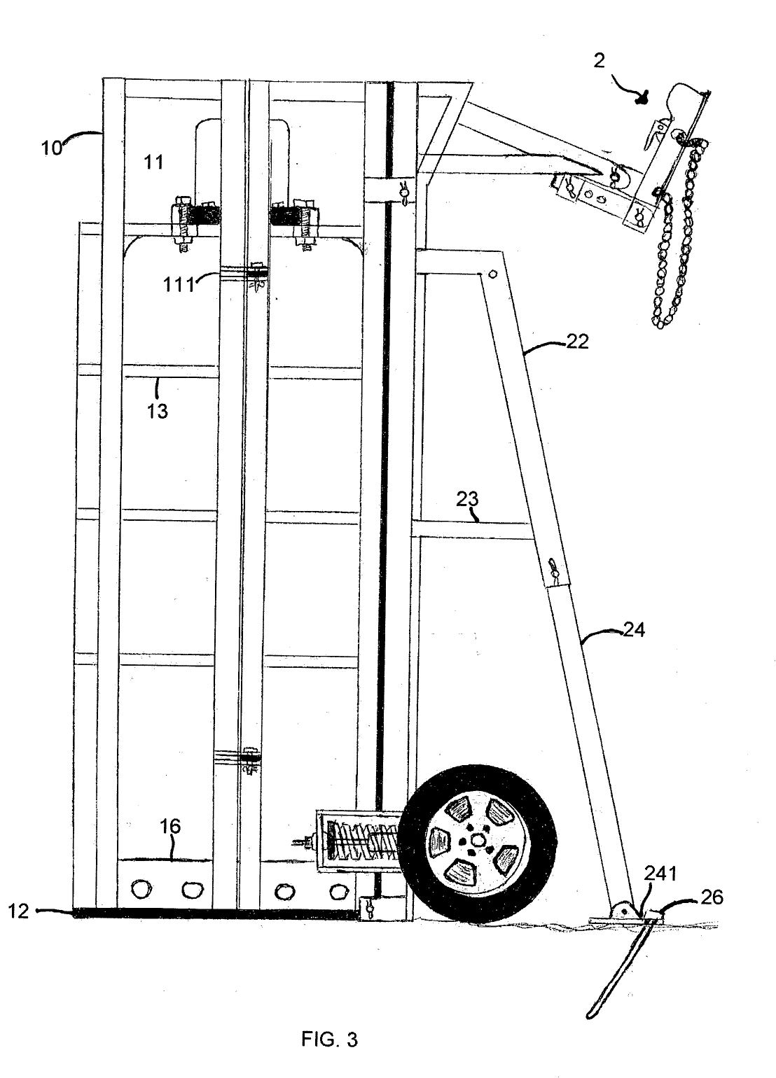

FIG. 3 illustrates a second embodiment of the apparatus of the invention. The apparatus includes a frame comprising a hitching structure 2 secured to the frame for receipt of a vehicle hitch, at least two wheels each secured to a side of the frame. A base 12 is coupled at a substantially perpendicular angle to at least one frame rail 10 and at a distal end of the frame rail 10. At least one transverse frame bracket 13 is secured to the frame rail 10. Moreover, at least one longitudinal frame brace secured to the frame that is securable in contact with the foundation when the apparatus is in a storage orientation. The frame brace is manipulable to avoid contact with the foundation when the apparatus is in a transport orientation.

As with the previous embodiment, the second embodiment also includes an anchoring structure having a first portion, which is secured to the foundation, and a second portion that is secured to the frame. Again, the first portion is connectable to the second portion to facilitate secure storage of the apparatus when the apparatus is in the storage orientation.

FIG. 3 illustrates a preferred first portion, which comprises a protrusion from the foundation (e.g. a rod or spike 26) and the second portion comprises an aperture on the frame adapted to receive the protrusion. FIG. 3 also illustrates the preferred frame brace, which comprises a first portion that is secured to the frame and a second portion which extends from the first portion to a securable position in contact with the foundation. As illustrated, the preferred second portion comprises a foot-pad 241 that is adapted to receive and be securable to a rod 26 extending from the foundation.

The second embodiment also includes a preferred frame having a first portion secured to the hitching structure, and a second portion hingedly securable to the first portion. The preferred second portion is hingedly securable on at least two sides of the frame.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. A securable transport apparatus for a tank, comprising:
a frame comprising a hitching structure secured to the frame for receipt of a vehicle hitch, at least two wheels each secured to a side of the frame, a base coupled at a substantially perpendicular angle to the frame and at a distal end of the frame, and at least one longitudinal frame rail secured to at least one transverse frame bracket; and
an anchoring mechanism having a first portion secured to an independent foundation and which is adapted to receive and secure the frame in a substantially vertical position.

2. The transport apparatus in claim 1 wherein,
the base further comprises a rim extending away from the base and adapted to coincide with a portion of the tank.

3. The transport apparatus in claim 1 wherein,
the frame further comprises an protrusion and eyelet

4. The transport apparatus in claim 1 wherein,
base comprises a base plate and a rim is coupled to the base plate.

5. The transport apparatus in claim 1 wherein,
the frame comprises two portions hingedly attached along the frame rail.

6. An apparatus for transport to and from, and stationary storage, of a gas canister upon a foundation, comprising:
a frame comprising a hitching structure secured to the frame for receipt of a vehicle hitch, at least two wheels each secured to a side of the frame, a base coupled at a substantially perpendicular angle to at least one frame rail and at a distal end of the frame rail, at least one transverse frame bracket secured to the frame rail, and at least one longitudinal frame brace secured to the frame that is securable in contact with the foundation when the apparatus is in a storage orientation, and manipulable to avoid contact with the foundation when the apparatus is in a transport orientation.

7. The apparatus in claim 6 further comprising,
an anchoring structure having a first portion which is secured to the foundation, and a second portion which is secured to the frame, the first portion connectable to the second portion to facilitate secure storage of the apparatus when the apparatus is in the storage orientation.

8. The apparatus in claim 6 wherein,
first portion comprises a protrusion from the foundation and the second portion comprises an aperture on the frame adapted to receive the protrusion.

9. The apparatus in claim 6 wherein,
the frame brace comprises a first portion that is secured to the frame and a second portion which extends from the first portion to a securable position in contact with the foundation.

10. The apparatus in claim 9 wherein,
the second portion further comprises a foot-pad that is adapted to receive and be securable to a rod extending from the foundation.

11. The apparatus in claim 6 wherein,
the frame comprises a first portion secured to the hitching structure, and a second portion hingedly securable to the first portion.

12. The apparatus in claim 10 wherein,
the second portion is hingedly securable on at least two sides of the frame.
